(19) United States
(12) Patent Application Publication
(10) Pub. No.: US 2022/0309981 A1
(43) Pub. Date: Sep. 29, 2022

(54) PIXEL DRIVING STRUCTURE AND DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Lixia Li, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 17/056,736

(22) PCT Filed: Sep. 22, 2020
(86) PCT No.: PCT/CN2020/116672

§ 371 Date: Nov. 18, 2020

(30) Foreign Application Priority Data
Aug. 12, 2020 (CN) 202010806234.0

(51) Int. Cl. G09G 3/20

(52) U.S. Cl. CPC G09G 3/2003; G09G 2320/0242; G09G 2300/0413; G09G 2300/0452

(57) ABSTRACT

A pixel driving structure is provided. The pixel driving structure includes: a plurality of scan lines and a plurality of data lines, the scan lines and the data lines are staggered to define pixels arranged in an array, and each of the data lines is connected to pixels of a same color. Each of the data lines only charges pixels of one color, therefore showing an image of a single color or a mixed color is a light-load operation, effectively reducing a risk of poor image display caused by insufficient charging of the pixels.

### TECHNICAL FIELD

The present application relates to a display technology field, and more particularly, to a pixel driving structure and a display device.

### BACKGROUND

In order to take into consideration increased pixel charging time and pixel aperture ratio, reduce a number of source driving chips used, and reduce manufacturing cost and power consumption, a tri-gate driving structure is proposed by persons skilled in this art.

Shown in FIG. 1 is a schematic structural diagram showing a pixel driving structure in the prior art. The pixel driving structure includes a plurality of scan lines arranged along a horizontal direction and a plurality of data lines arranged along a vertical direction. The scan lines and data lines are staggered to define a pixel area. A pixel array including red pixels (R), green pixels (G), and blue pixels (B) are disposed in the pixel area. One of the scan lines is connected to and drives pixels of a same color disposed in a row adjacent to it, and one of the data lines is connected to and drives the red pixels, the green pixels, and the blue pixels connected to it. Shown in FIG. 2 is a timing sequence chart for the pixel driving structure in the prior art. When an image of a single color or a double-color mixed color is shown by driving the pixel driving structure, potentials of driving voltages need to be switched repeatedly between high potentials and low potentials. Therefore, showing the image of the single color or the double-color mixed color is an overload operation. In this case, because ability of charging the pixels is poor, the pixels are prone to charge insufficiently, causing poor image display. In another aspect, when the potentials of the driving voltages are in a state of being switched between the high potentials and the low potentials, there will be a certain possibility of mischarging the pixels, and it occurs in pixels of different colors, so that color deviation is produced, thereby causing poor image display.

Therefore, the existing tri-gate driving structure has problems of insufficient charging or mischarging of the pixels, causing poor image display, which need to be solved.

### Technical Problem

The present application provides a pixel driving structure to improve problems of insufficient charging or mischarging of pixels in an existing tri-gate driving structure.

### Technical Solution

The present application provides a pixel driving structure, comprising:

a plurality of scan lines and a plurality of data lines, wherein the scan lines and the data lines are staggered to define pixels arranged in an array,

wherein each of the data lines is connected to pixels of a same color.

In the pixel driving structure provided by the present application, the pixels comprise n types of different colors, and the data lines are connected to the pixels of the n types of different colors in an alternating way.

In the pixel driving structure provided by the present application, a same one of the data lines is connected to pixels of a same color among n continuous columns of pixels adjacent to the same one of the data lines.

In the pixel driving structure provided by the present application, a first data line is disposed at a right side of a first column of the pixels, and a same one of the data lines is connected to pixels of a same color disposed in l columns of pixels that are located at a left side of the same one of the data lines and in (n−l) columns of pixels that are located at a right side of the same one of the data lines, where l is an integer greater than or equal to 1 and less than or equal to n.

In the pixel driving structure provided by the present application, first (n−l) columns of pixels and last (l−1) columns of pixels are all dummy pixels, and the dummy pixels do not emit light for display.

In the pixel driving structure provided by the present application, first (n−l) data lines are further connected to pixels of colors corresponding to the data lines among first (n−l) columns of pixels respectively, and last (l−1) data lines are further connected to pixels of colors corresponding to the data lines among last (l−1) columns of pixels respectively.

In the pixel driving structure provided by the present application, a first data line is disposed at a left side of a first column of pixels, and a same one of the data lines is connected to pixels of a same color disposed in m columns of pixels that are located at a left side of the same one of the data lines and in (n−m) columns of pixels that are located at a right side of the same one of the data lines, where m is an integer greater than or equal to 0.

In the pixel driving structure provided by the present application, first (n−m−1) columns of pixels and last m columns of pixels are all dummy pixels, and the dummy pixels do not emit light for display.

In the pixel driving structure provided by the present application, first (n−m) data lines are further connected to pixels of colors corresponding to the data lines among first (n−m−1) columns of pixels, respectively, and last m data lines are further connected to pixels of colors corresponding to the data lines among last m columns of pixels respectively.

In the pixel driving structure provided by the present application, the pixels construct pixel units that are repeated, any of the pixel units comprise n pixels sequentially arranged along a first direction with colors different from each other, and comprise p pixels sequentially arranged along a second direction, where p is an integer greater than or equal to 1.

In the pixel driving structure provided by the present application, the first direction is same as an extending direction of the scan lines.

In the pixel driving structure provided by the present application, the second direction is same as an extending direction of the scan lines.

In the pixel driving structure provided by the present application, colors of the pixels arranged along the second direction are same.

In the pixel driving structure provided by the present application, each of the pixel units comprises two pixels arranged along the second direction, and colors of the two pixels are different from each other.

Further, the present application provides a display device, comprising:

a display panel comprising a pixel driving structure, wherein the pixel driving structure comprises a plurality of scan lines and a plurality of data lines, the scan lines and the data lines are staggered to define pixels arranged in an array, and each of the data lines is connected to pixels of a same color;

a scan driving chip configured to input scan driving signals to the pixels through the scan lines; and

a data driving chip configured to input data driving signals to the pixels through the data lines,

wherein, in a case that an image is shown on the display panel, the scan driving signals are inputted to the pixels connected to the scan lines corresponding to colors of a to-be-shown image by the scan driving chip, the data driving signals are inputted to the pixels connected to the data lines corresponding to the colors of the to-be-shown image by the data driving chip, and the data driving signals are driving voltages that are at continuous high potentials.

In the display device provided by the present application, the pixels comprise n types of different colors, and the data lines are connected to the pixels of n types of different colors in an alternating way.

In the display device provided by the present application, a same one of the data lines is connected to pixels of a same color among n continuous columns of pixels adjacent to the same one of the data lines.

In the display device provided by the present application, a first data line is disposed at a right side of a first column of pixels, and a same one of the data lines is connected to pixels of a same color disposed in l columns of pixels that are located at a left side of the same one of the data lines and in (n−l) columns of pixels that are located at a right side of the same one of the data lines, where l is an integer greater than or equal to 1 and less than or equal to n.

In the display device provided by the present application, a first data line is disposed at a left side of a first column of pixels, and a same one of the data lines is connected to pixels of a same color disposed in m columns of pixels that are located at a left side of the same one of the data lines and in (n−m) columns of pixels located at a right side of the same one of the data lines, where m is an integer greater than or equal to 0.

In the display device provided by the present application, the pixels construct pixel units that are repeated, any of the pixel units comprise n pixels sequentially arranged along a first direction with colors different from each other, and comprise p pixels sequentially arranged along a second direction, where p is an integer greater than or equal to 1.

### Beneficial Effect

The present application provides a pixel driving structure and a display device. The pixel driving structure includes: a plurality of scan lines and a plurality of data lines, the scan lines and the data lines are staggered to define pixels arranged in an array, and each of the data lines is connected to pixels of a same color. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

### DESCRIPTION OF DRAWINGS

Technical schemes and other beneficial effects of the present application will be obvious through detailed descriptions of specific implementation examples provided by the present application in conjunction with appending drawings.

FIG. 1 is a schematic structural diagram showing a pixel driving structure in the prior art.

FIG. 2 is a timing sequence chart for the pixel driving structure in the prior art.

FIG. 3 is a schematic structural diagram showing a first structure of a pixel driving structure according to an embodiment of the present application.

FIG. 4 is a schematic structural diagram showing a second structure of a pixel driving structure according to an embodiment of the present application.

FIG. 5 is a schematic structural diagram showing a third structure of a pixel driving structure according to an embodiment of the present application.

FIG. 6 is a schematic structural diagram showing a fourth structure of a pixel driving structure according to an embodiment of the present application.

FIG. 7 is a schematic structural diagram showing pixel units according to an embodiment of the present application.

FIG. 8 is a timing sequence chart for the pixel driving structure according to an embodiment of the present application.

### DETAILED DESCRIPTION OF PREFERRED EMBODIMENTS

For a problem of poor image display caused by insufficient charging or mischarging of pixels in an existing tri-gate driving structure, the present application provides a pixel driving structure to solve the problem.

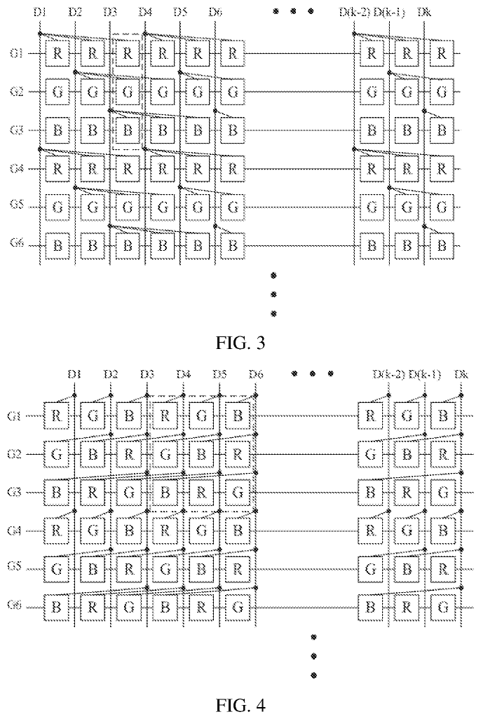

In an embodiment, refer to FIG. 3 to FIG. 6, which are schematic structural diagrams showing four structures of pixel driving structures respectively according to embodiments of the present application. As shown in the figures, the pixel driving structure provided by the present application includes:

a plurality of scan lines and a plurality of data lines, the scan lines and the data lines are staggered to define pixels arranged in an array; and

each of the data lines is connected to pixels of a same color.

The present embodiment provides a pixel driving structure. A same one of the data lines is only connected to pixels of one color, while an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

In the pixel driving structure provided by the embodiment of the present application, the pixels may include pixels of three different colors, such as red pixels R, green pixels G, and blue pixels B. The pixels may also include pixels of four different colors, such as red pixels R, green pixels G, blue pixels B, and white pixels W. The pixels may further include pixels of other colors. In the following specific embodiments, pixels including red pixels R, green pixels G, and blue pixels B are taken as examples to describe the pixel driving structures provided by the embodiments of the present application.

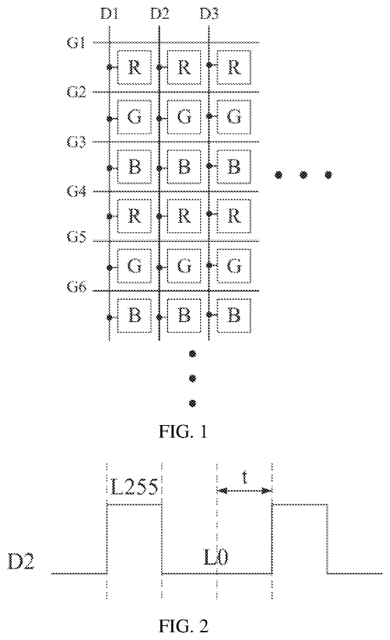

In a first embodiment, refer to FIG. 3, which is a schematic structural diagram showing a first structure of a pixel driving structure according to an embodiment of the present application. The pixel driving structure includes: a plurality of scan lines G1, G2, G3, G4, G5, G6, etc., the scan lines extend along a horizontal direction and are arranged at intervals in a vertical direction; a plurality of data lines D1, D2, D3, D4, D5, D6, . . . D(k−2), D(k−1), Dk, the data lines extend along the vertical direction and are arranged at intervals in the horizontal direction. The scan lines and lines are spatially staggered to define pixels arranged in an array: red pixels R, green pixels G, and blue pixels B. It should be noted here that drawing identification symbols of the pixels on the scan lines in FIG. 1 is only a requirement for illustration, and it does not mean that the pixels are disposed directly above the scan lines.

Each one of the scan lines is connected to a row of pixels adjacent to it. For example, a first scan line G1 is connected to a first row of pixels, a second scan line G2 is connected to a second row of pixels, etc. Each one of the data lines is simultaneously connected to pixels of a same color among three continuous columns of pixels adjacent to it.

As shown in FIG. 3, a first data line D1 is located at a left side of a first column of pixels, and a same one of the data lines is connected to pixels of a same color among three continuous columns of pixels located at a right side of the same one of the data lines and adjacent to the same one of the data lines. For example, the first data line D1 is connected to all red pixels R disposed in the first column of pixels, a second column of pixels, and a third column of pixels; a second data line D2 is connected to all green pixels G disposed in the second column of pixels, the third column of pixels, and a fourth column of pixels; and a third data line D3 is connected to all blue pixels B disposed in the third column of pixels, the fourth column of pixels, and a fifth column of pixels.

Further, different data lines are connected to red pixels R, green pixels G, and blue pixels B in an alternating way. For example, a fourth data line D4 is connected to all red pixels disposed in the fourth column of pixels, the fifth column of pixels, and a sixth column of pixels, a fifth data line D5 is connected to all green pixels disposed in the fifth column of pixels, the sixth column of pixels, and a seventh column of pixels, a sixth data line D6 is connected to all blue pixels disposed in the sixth column of pixels, the seventh column of pixels, and an eighth column of pixels, and so on. That is, all (3s+1)^{th} data lines are connected to red pixels R, all (3s+2)^{th} data lines are connected to green pixels G, and all (3s+3)^{th} data lines are connected to blue pixels B, where s is a positive integer.

In the pixel driving structure provided by the present embodiment, each data line is connected to pixels of a same color among three continuous columns of pixels located at a right side of the data line and adjacent to the data line. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation which is caused by the mischarging, which eventually causes a problem of poor image display. Therefore, display effects of a display panel are greatly improved.

As shown in FIG. 3, all green pixels G disposed in the first column of pixels are not connected to the data lines, and are unable to receive data voltages transmitted by the data lines, so that all of the green pixels G are unable to emit light for display. Similarly, all blue pixels B disposed in the first column of pixels and the second column of pixels are not connected to the data lines, and all of the blue pixels B are unable to receive data voltages transmitted by the data lines, so that all of the blue pixels B are unable to emit light for display. As a result, the first column of pixels is unable to emit green light, the first column of pixels and the second column of pixels are unable to emit blue light, and normal light mixing cannot be performed on the first column of pixels and the second column of pixels.

In order to solve this problem, in a first scheme, the first column of pixels and the second column of pixels are set as columns of dummy pixels, that is, all of the first column of pixels and the second column of pixels, including red pixels R, green pixels G, and blue pixels B, do not emit light, thereby preventing a problem of color deviation caused by uneven light mixing performed on the first column of pixels and the second column of pixels.

In a second scheme, the second data line D2 is further connected to green pixels G disposed in the first column of pixels that are located at a left side of the second data line D2 for transmitting data voltage signals to all green pixels G disposed in the first column of pixels, so that all of the green pixels G disposed in the first column of pixels may normally emit light for display. The third data line D3 is further connected to blue pixels B disposed in the first column of pixels and the second column of pixels that are located at a left side of the third data line D3 for transmitting data voltage signals to all blue pixels B disposed in the first column of pixels and the second column of pixels, so that all of the blue pixels B disposed in the first column of pixels and the second column of pixels may normally emit light for display. Therefore, a problem that the green pixels G disposed in the first column of pixels and the blue pixels B disposed in the first column of pixels and the second column of pixels are unable to emit light, and the problem of color deviation caused by unnormal light mixing performed on the first column of pixels and the second column of pixels are prevented.

In a second embodiment, refer to FIG. 4, which is a schematic structural diagram showing a second structure of a pixel driving structure according to an embodiment of the present application. The same contents of the pixel driving structure as the first embodiment are no longer repeated. In contrast to the first embodiment, a first data line D1 is located at a right side of the first column of pixels, and each one of the data lines is simultaneously connected to pixels of a same color among three continuous columns of pixels located at a left side of the each one of the data lines and adjacent to the each one of the data lines. For example, a fourth data line D4 is connected to all red pixels R disposed in a second column of pixels, a third column of pixels, and a fourth column of pixels, a fifth data line D5 is connected to all green pixels G disposed in the third column of pixels, the fourth column of pixels, and a fifth column of pixels, and a sixth data line D6 is connected to all blue pixels B disposed in the fourth column of pixels, the fifth column of pixels, and a sixth column of pixels.

In the pixel driving structure provided by the present embodiment, each one of the data lines is connected to pixels of a same color among three continuous columns of pixels located at a left side of the each one of the data lines and adjacent to the each one of the data lines. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

Similarly, as shown in FIG. 4, all green pixels G disposed in a k^{th} column of pixels are not connected to the data lines, and all of the green pixels G are unable to receive data voltages transmitted by the data lines, so that all of the green pixels G are unable to emit light for display. All blue pixels B disposed in the k^{th} column of pixels and a (k−1)^{th} column of pixels are not connected to the data lines, and all of the blue pixels B are unable to receive data voltages transmitted by the data lines, so that all of the blue pixels B are unable to emit light for display. As a result, the k^{th} column of pixels is unable to emit green light, the k^{th} column of pixels and the (k−1)^{th} column of pixels are unable to emit blue light, and normal light mixing cannot be performed on the first column of pixels and the second column of pixels.

In a first scheme, the k^{th} column of pixels and the (k−1)^{th} column of pixels are set as columns of dummy pixels, that is, all of the k^{th} column of pixels and the (k−1)^{th} column of pixels, including red pixels R, green pixels G, and blue pixels B, do not emit light, thereby preventing a problem of color deviation caused by uneven light mixing performed on the k^{th} column of pixels and the (k−1)^{th} column of pixels.

In a second scheme, a (k−1)^{th} data line D(k−1) is further connected to green pixels G disposed in the k^{th} column of pixels that are located at a right side of the second data line D(k−1) for transmitting data voltage signals to all green pixels G disposed in the k^{th} column of pixels, so that the green pixels G disposed in the k^{th} column of pixels may normally emit light for display. A (k−2)^{th} data line D(k−2) is further connected to red pixels R disposed in the k^{th} column of pixels and the (k−1)^{th} column of pixels that are located at a right side of the (k−2)^{th} data line D(k−2) for transmitting data voltage signals to all red pixels R disposed in the k^{th} column of pixels and the (k−1)^{th} column of pixels, so that the red pixels R disposed in the k^{th} column of pixels and the (k−1)^{th} column of pixels may normally emit light for display. Therefore, a problem that the green pixels G disposed in the k column of pixels and the red pixels R disposed in the k^{th} column of pixels and the (k−1)^{th} column of pixels are unable to emit light, and a problem of color deviation caused by unnormal light mixing performed on the k^{th} column of pixels and the (k−1)^{th} column of pixels are prevented.

In a third embodiment, refer to FIG. 5, which is a schematic structural diagram showing a third structure of a pixel driving structure according to an embodiment of the present application. The same contents of the pixel driving structure as the second embodiment are no longer repeated. In contrast to the second embodiment, each one of the data lines is simultaneously connected to a column of pixels located at a left side of the each one of the data lines and adjacent to the each one of the data lines, and is connected to pixels of a same color among two continuous columns of pixels located at a right side of the each one of the data lines and adjacent to the each one of the data lines. For example, a first data line D1 is connected to all red pixels R disposed in a first column of pixels, a second column of pixels, and a third column of pixels, a second data line D2 is connected to all green pixels G disposed in the second column of pixels, the third column of pixels, and a fourth column of pixels, and a third data line D3 is connected to all blue pixels B disposed in the third column of pixels, the fourth column of pixels, and a fifth column of pixels.

In the pixel driving structure provided by the present embodiment, each one of the data lines is simultaneously connected to a column of pixels located at a left side of the each one of the data lines and adjacent to the each one of the data lines, and is connected to pixels of a same color among two continuous columns of pixels located at a right side of the each one of the data lines and adjacent to the each one of the data lines. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

Similarly, as shown in FIG. 5, similar to the first embodiment, all green pixels G disposed in the first column of pixels are not connected to the data lines, and all of the green pixels G are unable to receive data voltages transmitted by the data lines, so that all of the green pixels G are unable to emit light for display. All blue pixels B disposed in the first column of pixels the second column of pixels are not connected to the data lines, and all of the blue pixels B are unable to receive data voltages transmitted by the data lines, so that all of the blue pixels B are unable to emit light for display. As a result, the first column of pixels is unable to emit green light, the first column of pixels and the second column of pixels are unable to emit blue light, and normal light mixing cannot be performed on the first column of pixels and the second column of pixels. To solve this problem, the first scheme and the second scheme in the first embodiment can be adopted, and for specific details, please refer to the above-mentioned schemes, and they will not be repeated here.

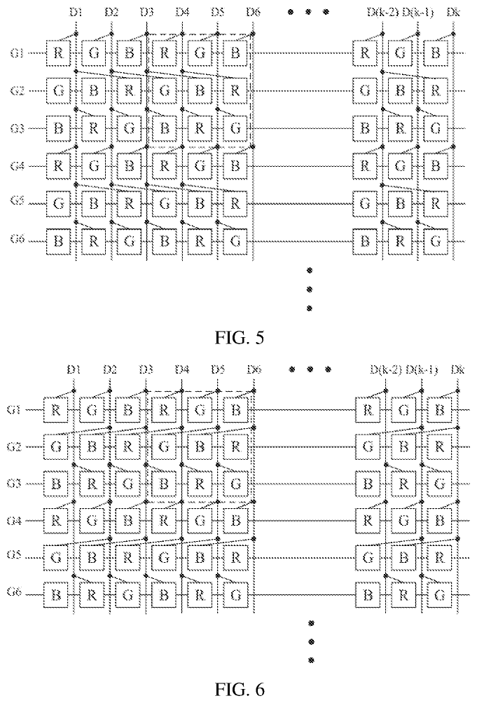

In a fourth embodiment, refer to FIG. 6, which is a schematic structural diagram showing a fourth structure of a pixel driving structure according to an embodiment of the present application. The same contents of the pixel driving structure as the third embodiment are no longer repeated. In contrast to the third embodiment, each one of the data lines is connected to a column of pixels located at a right side of the each one of the data lines and adjacent to the each one of the data lines, and is connected to pixels of a same color among two continuous columns of pixels that are located at a left side of the each one of the data lines and adjacent to the each one of the data lines. For example, a fourth data line D4 is connected to all red pixels R disposed in a third column of pixels, a fourth column of pixels, and a fifth column of pixels, a fifth data line D5 is connected to all green pixels G disposed in the fourth column of pixels, the fifth column of pixels, and a sixth column of pixels, and a sixth data line D6 is connected to all blue pixels B disposed in the fifth column of pixels, the sixth column of pixels, and a seventh column of pixels.

In the pixel driving structure provided by the present embodiment, each one of the data lines is connected to a column of pixels that is located at a right side of the each one of the data lines and is adjacent to the each one of the data lines, and is connected to pixels of a same color among two continuous columns of pixels that are located at a left side of the each one of the data lines and is adjacent to the each one of the data lines. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

As shown in FIG. 6, all blue pixels B disposed in a first column of pixels are not connected to the data lines, and all of the blue pixels B are unable to receive data voltages transmitted by the data lines, and all of the blue pixels B are unable to emit light for display. All red pixels R disposed in a k^{th} column of pixels are not connected to the data lines, all of the red pixels R are unable to receive data voltages transmitted by the data lines, and all of the red pixels R are unable to emit light for display. As a result, the first column of pixels is unable to emit blue light, the k^{th} column of pixels are unable to emit red light, and normal light mixing cannot be performed on the first column of pixels and the k^{th} column of pixels.

In a first scheme, the first column of pixels and the k^{th} column of pixels are columns of dummy pixels, that is, all of the first column of pixels and the k^{th} column of pixels do not emit light, thereby preventing a problem of color deviation caused by uneven light mixing performed on the first column of pixels and the k^{th} column of pixels.

In a second scheme, a third data line D3 is further connected to blue pixels B disposed in the first column of pixels that is located at a left side of the third data line D3 for transmitting data voltage signals to all blue pixels B disposed in the first column of pixels, so that the blue pixels B disposed in the first column of pixels may normally emit light for display. The (k−2)^{th} data line D(k−2) is further connected to red pixels R disposed in the k^{th} column of pixels that is located at a right side of the (k−2)^{th} data line D(k−2) for transmitting data voltage signals to all red pixels R disposed in the k^{th} column of pixels, so that the red pixels R disposed in the k^{th} column of pixels may normally emit light for display. Therefore, a problem that the blue pixels B disposed in the first column of pixels and the red pixels R disposed in the k^{th} column of pixels are unable to emit light for display, and a problem of color deviation caused by unnormal light mixing performed on the first column of pixels and the k^{th} column of pixels are prevented.

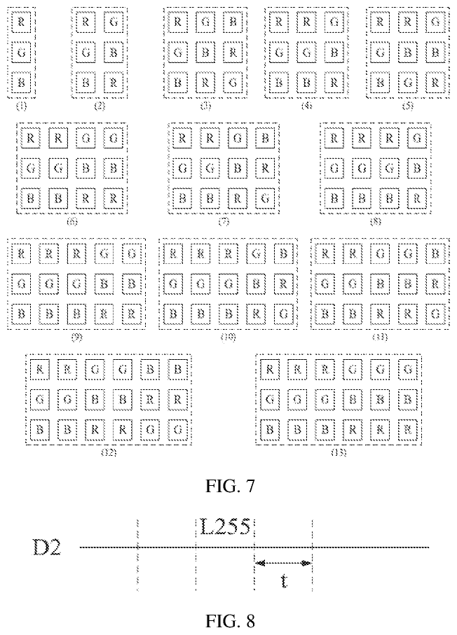

Refer to FIG. 7, which is a schematic structural diagram showing pixel units according to an embodiment of the present application. In the pixel driving structures provided by the present application, a pixel array is constructed by pixel units that are repeated, and the pixel units are constructed by pixels arranged in an 3*p array, where p is an integer greater than or equal to 1, and a direction corresponding to 3 may be a horizontal direction, 3 means a number of columns. A direction corresponding to 3 may also be a vertical direction, 3 is a number of rows. Along the direction corresponding to 3, red pixels R, green pixels G, and the blue pixels B are arranged in sequence.

Terms that the direction corresponding to 3 is the vertical direction as well as 3 is the number of rows are taken as examples for structures of the pixel units in FIG. 7. The pixel units provided by the embodiment of the present application will be described in detail below in conjunction with FIG. 7. Correspondingly, an embodiment that the direction corresponding to 3 is the horizontal direction and 3 is the number of columns is a reverse embodiment of which the direction corresponding to 3 is the vertical direction and 3 is the number of rows. It should be noted that, only parts of schematic diagrams of the pixel units claimed in the embodiment of the present application are showed in FIG. 7. Structures of the pixel units required to be protected in the embodiment of the present application are far more than the limited ones in the figure, and all structures of the pixel units that meet the claims of the present application are within the protection contents of the present application.

In a first implementation example, a value of p is 1, as shown in (1) of FIG. 7, a red pixel R, a green pixel G, and a blue pixel B are sequentially arranged in a column to form a 3*1 pixel unit.

In a second implementation example, the value of p is 2, as shown in (2) of FIG. 7. Along the vertical direction, a red pixel, a green pixel G, and a blue pixel B are sequentially arranged in a column. Along the horizontal direction, a number of pixels is two, and colors of the two pixels are different from each other. The colors of the two pixels may be any two of a red color, a green color, and a blue color. It is not limited to the structure shown in (2) of FIG. 7.

In a third implementation example, the value of p is 3, as shown in (3) to (5) of FIG. 7. Along the vertical direction, a red pixel R, a green pixel G, and a blue pixel B are sequentially arranged in a column. Along the horizontal direction, a number of pixels is three, and at least two of the three pixels have different colors, permutation of which includes, but is not limited to, the structures shown in (3) to (5) of FIG. 7.

In a fourth implementation example, the value of p is 4, as shown in (6) to (8) of FIG. 7. Along the vertical direction, a red pixel R, a green pixel G, and a blue pixel B are sequentially arranged in a column. Along the horizontal direction, a number of pixels is four, and at least two of the four pixels have different colors, permutation of which includes, but is not limited to, the structures shown in (6) to (8) of FIG. 7.

In a fifth implementation example, the value of p is 5, as shown in (9) to (11) of FIG. 7. Along the vertical direction, a red pixel R, a green pixel G, and a blue pixel B are sequentially arranged in a column. Along the horizontal direction, a number of pixels is five, and at least two of the five pixels have different colors, permutation of which includes, but is not limited to, the structures shown in (9) to (11) of FIG. 7.

In a sixth implementation example, the value of p is 6, as shown in (12) to (13) of FIG. 7. Along the vertical direction, a red pixel R, a green pixel G, and a blue pixel B are sequentially arranged in a column. Along the horizontal direction, a number of pixels is six, and at least two of the six pixels have different colors, permutation of which includes, but is not limited to, the structures shown in (12) to (13) of FIG. 7.

In other implementation examples, p may also be other values. Similarly, along the vertical direction, a red pixel R, a green pixel G, and a blue pixel B are sequentially arranged in a column. Specifically, it can be extended in combination with the above-mentioned implementation examples.

The pixel driving structures provided by the embodiments of the present application may be arbitrarily composed of the pixel array that is constructed by the pixel units provided by the above-mentioned implementation examples and the scan lines and the data lines that are provided by the above-mentioned embodiments. Persons skilled in this art may make extensions that do not exceed the protection scope of the present invention on the basis of the above-mentioned embodiments, and technical solutions obtained by the extensions are also protected by the present application.

Furthermore, the present application also provides a method for driving pixels, which is configured to drive the pixel driving structure provided by the embodiments of the present application. In an embodiment, the method for driving the pixels includes steps of:

inputting scan driving signals to the pixels connected to the scan lines corresponding to a color of a to-be-shown image, and inputting data driving signals to the pixels connected to the data lines corresponding to the color of the to-be-shown image in a case that an image is shown, the data driving signals are driving voltages which are at continuous high potentials.

The color of the to-be-shown image described here is: an image color in a case that an image of a single color is displayed, such as a red color, a green color, or a red color; a single color used for mixing colors in a case that an image of a mixed color is displayed, such as a red color and a green color, a red color and a blue color, a green color and a blue color, or red, green, and blue colors.

Refer to FIG. 8, which is a timing sequence chart for driving the pixels according to an embodiment of the present application. Specifically, the timing sequence chart is a timing sequence chart corresponding to the (3s+2)^{th} data line D(3s+2) of the pixel driving structure in FIG. 5 in a case that an image of a green color is showed. In the case that the image of the green color is showed, driving voltages at continuous high potentials are inputted to green pixels connected to the (3s+2)^{th} data line D(3s+2).

Similarly, In the case that an image of a mixed-color is shown, driving voltages at continuous high potentials are inputted to pixels connected to the data lines corresponding to a single color used for mixing colors in a to-be-shown image.

The present embodiment provides a method for driving the pixels, the method includes that in a case that an image is shown, the scan driving signals are inputted to the pixels connected to the scan lines corresponding to a color of a to-be-shown image, the data driving signals are inputted to the pixels connected to the data lines corresponding to the color of the to-be-shown image, and the data driving signals are driving voltages which are at continuous high potentials. Showing the image is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

An embodiment of the present application further provides a display device, which includes:

a display panel including a pixel driving structure, and the pixel driving structure includes a plurality of scan lines and a plurality of data lines, the scan lines and the data lines are staggered to define pixels arranged in an array, and each of the data lines is connected to pixels of a same color;

a scan driving chip configured to input scan driving signals to the pixels through the scan lines;

a data driving chip configured to input data driving signals to the pixel through the data line,

in a case that an image is shown on the display panel, the scan driving signals are inputted to the pixels connected to the scan lines corresponding to a color of a to-be-shown image by the scan driving chip, the data driving signals are inputted to the pixels connected to the data lines corresponding to the color of the to-be-shown image by the data driving chip, and the data driving signals are driving voltages which are at continuous high potentials.

An embodiment of the present application provides a display device, which includes the pixel driving structure provided by the embodiments of the present application. The pixel driving structure includes a plurality of scan lines and a plurality of data lines, the scan lines and the data lines are staggered to define pixels arranged in an array, and each of the data lines is connected to pixels of a same color. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation which is caused by the mischarging, which eventually causes a problem of poor image display. Therefore, display effects of a display panel are greatly improved.

Since the display device provided by the embodiment of the present application includes the pixel driving structure provided in any one of the embodiments of the present application, the display device has the beneficial effects of the pixel driving structure provided by the embodiments of the present application. Specific implementation and working principles of which may refer to the above-mentioned embodiments, which will not be repeated here.

According to the above-mentioned embodiments, it can be known:

The present application provides the pixel driving structure and the display device, and the pixel driving structure includes the plurality of scan lines and the plurality of data lines, the scan lines and the data lines are staggered to define pixels arranged in an array, and each of the data lines is connected to pixels of a same color. While an image of a single color or a double-color mixed color is showed by driving the pixel driving structure, driving voltages on the data lines are at continuous high potentials, so that showing the image of the single color or the double-color mixed color is a light-load operation. In this case, ability of charging the pixels is strong, effectively reducing a risk of poor image display caused by insufficient charging of the pixels. Furthermore, each of the data lines only charges pixels of one color, and the driving voltages on the data lines are at continuous high potentials, preventing a problem of mischarging the pixels and preventing color deviation caused by the mischarging, which eventually causes a problem of poor image display. Therefore, display effects of a display panel are greatly improved.

Above all, although the present application has been disclosed above in the preferred embodiments, the above preferred embodiments are not intended to limit the present application. For persons skilled in this art, various modifications and alterations can be made without departing from the spirit and scope of the present application. The protective scope of the present application is subject to the scope as defined in the claims.

1. A pixel driving structure, comprising:
a plurality of scan lines and a plurality of data lines, wherein the scan lines and the data lines are staggered to define pixels arranged in an array,
wherein each of the data lines is connected to pixels of a same color.

2. The pixel driving structure as claimed in claim 1, wherein the pixels comprise n types of different colors, and the data lines are connected to the pixels of the n types of different colors in an alternating way.

3. The pixel driving structure as claimed in claim 2, wherein a same one of the data lines is connected to pixels of a same color among n continuous columns of pixels adjacent to the same one of the data lines.

4. The pixel driving structure as claimed in claim 3, wherein each of the data lines is disposed at a right side of each column of the pixels, a same one of the data lines is connected to pixels of a same color disposed in l columns of pixels that are located at a left side of the same one of the data lines and in (n−l) columns of pixels that are located at a right side of the same one of the data lines, where l is an integer greater than or equal to 1 and less than or equal to n.

5. The pixel driving structure as claimed in claim 4, wherein first (n−l) columns of pixels and last (l−1) columns of pixels are all dummy pixels, and the dummy pixels do not emit light for display.

6. The pixel driving structure as claimed in claim 4, wherein first (n−l) data lines are further connected to pixels of colors corresponding to the data lines among first (n−l) columns of pixels, respectively, and last (l−1) data lines are further connected to pixels of colors corresponding to the data lines among last (l−1) columns of pixels respectively.

7. The pixel driving structure as claimed in claim 3, wherein each of the data lines is disposed at a left side of each column of the pixels, a same one of the data lines is connected to pixels of a same color disposed in m columns of pixels that are located at a left side of the same one of the data lines and in (n−m) columns of pixels that are located at a right side of the same one of the data lines, where m is an integer greater than or equal to 0.

8. The pixel driving structure as claimed in claim 7, wherein first (n−m−1) columns of pixels and last m columns of pixels are all dummy pixels, and the dummy pixels do not emit light for display.

9. The pixel driving structure as claimed in claim 7, wherein first (n−m) data lines are further connected to pixels of colors corresponding to the data lines among first (n−m−1) columns of pixels, respectively, and last m data lines are further connected to pixels of colors corresponding to the data lines among last m columns of pixels respectively.

10. The pixel driving structure as claimed in claim 2, wherein the pixels construct pixel units that are repeated, any of the pixel units comprise n pixels sequentially arranged along a first direction with colors different from each other, and comprise p pixels sequentially arranged along a second direction, where p is an integer greater than or equal to 1.

11. The pixel driving structure as claimed in claim 10, wherein the first direction is same as an extending direction of the scan lines.

12. The pixel driving structure as claimed in claim 10, wherein the second direction is same as an extending direction of the scan lines.

13. The pixel driving structure as claimed in claim 10, wherein colors of the pixels arranged along the second direction are same.

14. The pixel driving structure as claimed in claim 10, wherein each of the pixel units comprises two pixels arranged along the second direction, and colors of the two pixels are different from each other.

15. A display device, comprising:
a display panel comprising a pixel driving structure, wherein the pixel driving structure comprises a plurality of scan lines and a plurality of data lines, the scan lines and the data lines are staggered to define pixels arranged in an array, and each of the data lines is connected to pixels of a same color;
a scan driving chip configured to input scan driving signals to the pixels through the scan lines; and
a data driving chip configured to input data driving signals to the pixels through the data lines,
wherein, in a case that an image is showed on the display panel, the scan driving signals are inputted to the pixels connected to the scan lines corresponding to a color of a to-be-shown image by the scan driving chip, the data driving signals are inputted to the pixels connected to the data lines corresponding to the color of the to-be-shown display image by the data driving chip, and the data driving signals are driving voltages that are at continuous high potentials.

16. The display device as claimed in claim 15, wherein the pixels comprise n types of different colors, and the data lines are connected to the pixels of n types of different colors in an alternating way.

17. The display device as claimed in claim 16, wherein a same one of the data lines is connected to pixels of a same color among n continuous columns of pixels adjacent to the same one of the data lines.

18. The display device as claimed in claim 17, wherein each of the data lines is disposed at a right side of each column of the pixels, a same one of the data lines is connected to pixels of a same color disposed in l columns of pixels that are located at a left side of the same one of the data lines and in (n−l) columns of pixels that are located at a right side of the same one of the data lines, where l is an integer greater than or equal to 1 and less than or equal to n.

19. The display device as claimed in claim 17, wherein each of the data lines is disposed at a left side of each column of the pixels, a same one of the data lines is connected to pixels of a same color disposed in m columns of pixels that are located at a left side of the same one of the data lines and in (n−m) columns of pixels located at a right side of the same one of the data lines, where m is an integer greater than or equal to 0.

20. The display device as claimed in claim 16, wherein the pixels construct pixel units that are repeated, any of the pixel units comprises n pixels sequentially arranged along a first direction with colors different from each other, and comprise p pixels sequentially arranged along a second direction, where p is an integer greater than or equal to 1.
